(19) United States
(12) Patent Application Publication
(10) Pub. No.: US 2010/0226280 A1
(43) Pub. Date: Sep. 9, 2010

(54) REMOTE SECURE ROUTER CONFIGURATION

(75) Inventors: John Arley BURNS, Houston, TX (US); Edward J. BLEVINS, Austin, TX (US)

Correspondence Address: CONLEY ROSE, P.C.;David A. Rose, P. O. BOX 3267, HOUSTON, TX, 77253-3267, US

(73) Assignee: ERF WIRELESS, INC., League City, TX (US)

(21) Appl. No.: 12/396,616

(22) Filed: Mar. 3, 2009

(51) Int. Cl. H04L 12/28; G06F 17/30; H04L 29/06

(52) U.S. Cl. 370/254; 726/28; 370/401; 713/150

(57) ABSTRACT

Systems and methods for securing a data communication network are described herein. An illustrative system includes a first router and an external storage device. The external storage device contains data that configures the first router. The external storage device is remotely coupled to the first router to configure the first router. The data that configures the first router includes the definition of a secure data path between the first router and a second router.

### RELATED APPLICATIONS

This application contains subject matter that may be related to U.S. Nonprovisional application Ser. No. 11/533,652, filed Sep. 20, 2006 and entitled “Router for Use in a Monitored Network,” to U.S. Nonprovisional application Ser. No. 11/533,672, filed Sep. 20, 2006 and entitled “Monitoring Server For Monitoring A Network Of Routers,” to U.S. Nonprovisional application Ser. No. 11/689,712, filed Mar. 22, 2007 and entitled “Safeguarding Router Configuration Data,” and to U.S. Nonprovisional application Ser. No. 11/777,704, filed Jul. 13, 2007 and entitled “Separate Secure Networks Over a Non-Secure Network” all of which are herein incorporated by reference.

### BACKGROUND

Routers are electrical devices that are used to permit computers and networks of computers to pass data back and forth. A router typically has one or more input ports and one or more output ports. Data packets containing a destination address arrive on an input port. Based on the destination address, the router forwards the data packet to an appropriate output port which may be connected to the destination computer system or to another router. The data being transmitted between routers may be confidential (e.g., bank account data in the context of a bank's network) and thus the security of such data should be ensured. Accordingly, at least some routers provide encryption to allow secure communications across an untrusted communication channel, such as the Internet.

Additionally, some such routers provide additional security to protect the configuration of the routers themselves. Such configuration protection measures sometimes operate by requiring physical attachment of a configuration device to a router to establish communication pathways between routers. The configuration device is presumed to be controlled by a person or group of persons authorized to configure the router, and consequently to control all, or a part of, the data traffic through the router. Further enhancements to the security of the router and the router configuration are desirable.

### SUMMARY

Systems and methods for securing a data communication network are described herein. Embodiments of the present disclosure include an external configuration device that contains router configuration data. The external configuration device need not be physically attached to a router to transfer configuration data, but rather the external configuration device may be remotely coupled to the router by, for example, a wireless communication system. In some embodiments, network security is enhanced by locating the external configuration device and the router in separate security zones that are accessible only to authorized users of the particular device located in the security zone. Moreover, the router and/or external security device can provide enhanced security by authenticating its respective user and/or the user of the other device and/or the device to which it is remotely coupled.

In accordance with at least some embodiments, a system includes a first router and an external storage device. The external storage device contains data that configures the first router. The external storage device is remotely coupled to the first router to configure the first router. The data that configures the first router includes a definition of a secure data path between the first router and a second router.

In other embodiments, a method includes establishing a secure communication link between a first router and an external storage device. The secure communication link remotely couples the external storage device to the first router. Configuration data is transferred from the external storage device to the first router to configure a secure data path between the first router and a second router.

In yet other embodiments, a storage device includes a router interface that remotely couples the storage device to a first router and router configuration data comprising information defining a secure data path between the first router and a second router.

### BRIEF DESCRIPTION OF THE DRAWINGS

For a detailed description of the illustrative embodiments of the invention, reference will now be made to the accompanying drawings in which:

FIG. 1 shows a network routing system utilizing a router constructed in accordance with at least some illustrative embodiments;

FIG. 2 shows a configuration device and a maintenance device, both coupled to a router constructed in accordance with at least some illustrative embodiments;

FIG. 3 shows a system including a router and an associated configuration device that are physically isolated in accordance with various embodiments;

FIG. 4 shows a block diagram of a configuration device adapted to remotely couple to a router in accordance with various embodiments; and

FIG. 5 shows a flow diagram for a method for configuring a router in a first security zone using a configuration device in a second security zone in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

Additionally, the term “system” refers to a collection of two or more hardware and/or software components, and may be used to refer to an electronic device, such as a computer, a network router, a portion of a computer or a network router, a combination of computers and/or network routers, etc. Further, the term “software” includes any executable code capable of running on a processor, regardless of the media used to store the software. Thus, code stored in non-volatile memory, and sometimes referred to as “embedded firmware,” is included within the definition of software. Also, the term “secure,” within the context of secure data, indicates that data has been protected so that access by unauthorized personnel is either prevented, or made sufficiently difficult such that breaching the protection measures is rendered impractical or prohibitively expensive relative to the value of the data.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. The discussion of any embodiment is meant only to be illustrative of that embodiment, and not intended to intimate that the scope of the disclosure, including the claims, is limited to that embodiment.

Routers are sometimes used as transfer points between secured and unsecured networks. When so utilized, the routers may be configured to protect data originating from, or destined for, a secure network and/or device. Such protection may include encryption of the data prior to transmission across an unsecured network (e.g., IPSec, RSA Public/Private Key Encryption, and Virtual Private Networks) as well as secure and/or encrypted authentication of a router on one end of the transaction by the router at the other end of the transaction (e.g., digital signatures). Because the configuration of these routers is a key element to ensuring data security, it is important to secure and control access to the configuration data of such routers. Embodiments of the present disclosure provide such security by requiring access to each router in a network through a unique configuration device. Some embodiments require physical attachment of the configuration device to the router. Some embodiments provide enhanced security by physically isolating the configuration device from the router during router configuration.

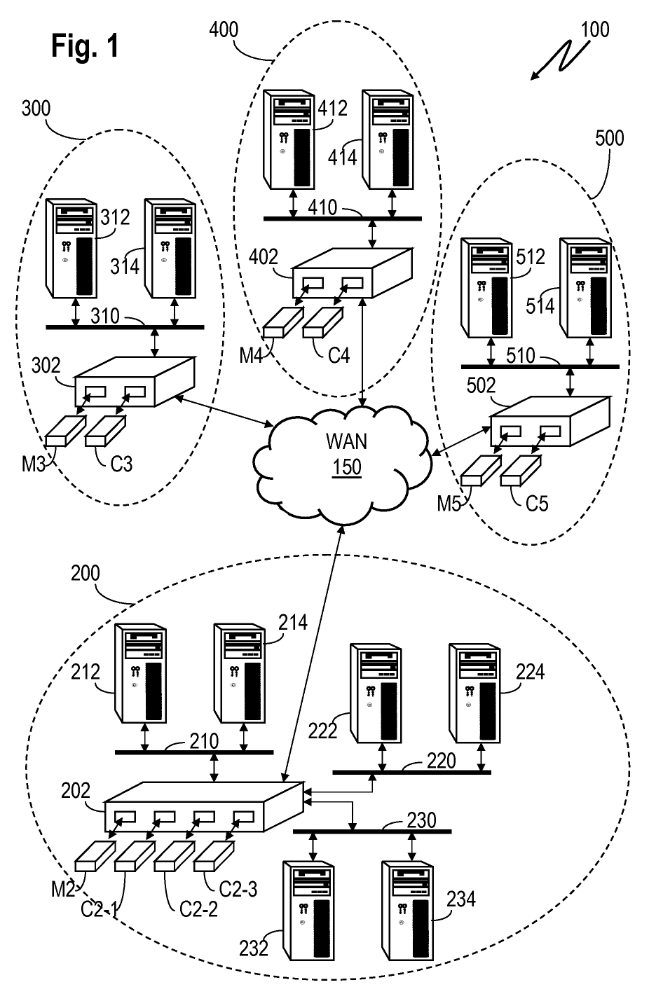

FIG. 1 shows a networked system 100 that incorporates a router 202, constructed in accordance with at least some illustrative embodiments, that provides the distributed configuration control described above. Although the illustrative embodiment shown and described includes a network router, other illustrative embodiments may include different or additional devices, such as network switches and/or hubs, and all such devices are within the scope of the present disclosure. Four sub-networks (200, 300, 400 and 500) are shown that couple to each other via wide area network (WAN) 150. A WAN 150 as defined herein comprises any network and networking technology used to connect local area networks. Each sub-network comprises a router (202, 302, 402 and 502 respectively) that provides connectivity between WAN 150 and one or more local area networks (LANs) coupled to each router. The LANs within each sub-network (LANs 210, 220, 230, 310, 410 and 510) couple one or more computer systems (212, 214, 222, 224, 232, 234, 312, 314, 412, 414, 512 and 514) to the router corresponding to a given sub-network, thus providing each computer system on each LAN connectivity to WAN 150 and to each of the other computer systems on each LAN.

Each router isolates the LANs to which the router couples from WAN 150 and other LANs by controlling and verifying where data is allowed to be sent and received, and by encrypting data before it is transmitted across WAN 150. For example, if a user wishes to transmit secure data from computer system 212 on LAN 210 to computer system 514 on LAN 510, router 202 is configured to allow the specific type and security level of data to be transmitted from computer system 212 to computer system 514 by the user attempting to send the data. Router 202 establishes a connection with router 502 and sets up a “tunnel” or secure data path through WAN 150 wherein the contents of the packets, including the network protocol headers of the messages as received from the respective LANs, are encrypted and encapsulated according to the networking protocol of WAN 150 (e.g., TCP/IP and IPsec). In this manner, the data being transmitted (and its LAN headers) appears in clear text form only on the source and destination LANs, and is otherwise visible on all other intervening networks only in encrypted form.

The security of the “tunneled” data (encrypted, encapsulated and transmitted across WAN 150) depends significantly on the security of the configuration of each of the routers. In at least some illustrative embodiments, each router of FIG. 1 protects its configuration through the use of an external maintenance device (M2, M3, M4 and M5), and one or more external configuration devices (C2-1, C2-2, C2-3, C3, C4 and C5), each of which may be under the control of a separate user. Each separate user and/or each external device may be authenticated before the configuration of the router can be loaded and/or modified. In at least some illustrative embodiments, the devices are non-volatile storage devices. The devices couple to the routers by a variety of means. In some embodiments, the devices physically couple to the routers via, for example, Universal Serial Bus (USB) style connectors. Some embodiments provide enhanced security by prohibiting physical connection of the configuration device to the router as explained below.

As can be seen in the illustrative embodiment of FIG. 1, routers 302, 402 and 502 each utilize a single maintenance device (M3, M4 and M5) and a single configuration device (C3, C4 and C5) to configure each router. Each device may be under the control of separate individuals or organizations, and each device as well as each user of each device is preferably authenticated by the router and/or the configuration device. Similarly, each router may be controlled by a different individual or organization and each router and/or router user is preferably authenticated to the configuration device and/or the router. As a result, in at least some illustrative embodiments a minimum of two individual users are required to alter the configuration of a router. Additional individuals or organizations may be assigned physical control of each configuration device (i.e., custodians of the devices), further enhancing security and discouraging collusion among malicious users. Upon configuration of the router, the router and the configuration device may each authenticate the other by decrypting identification data stored on the unit being authenticated, using an embedded decryption key stored within the authenticating unit. Each user of each router/configuration device may be authenticated by comparing authentication data provided by a user against reference authentication data stored either within the router or within the configuration device. The authentication data may be provided by the user in the form of a user ID and password entered via a keyboard, mouse, etc. coupled to the router/configuration device, or in the form of biometric data, such as a fingerprint provided via an appropriate scanning device coupled to the router/configuration device. Other mechanisms for providing user authentication data will become apparent to those of ordinary skill in the art, and all such mechanisms are within the scope of the present disclosure.

Continuing to refer to FIG. 1, router 202 utilizes maintenance and configuration devices similar to those used by the other routers, but router 202 is capable of accepting multiple configuration devices. Each configuration device (C2-1, C2-2 and C2-3) is capable of configuring router 202 to route data and to connect to source and destination computer systems under the control of specific individuals and/or organizations. Each individual/organization may control access to a configuration device, and each preferably provides separate authentication data for their corresponding device. By providing separate configuration data, router 202 may be configured to provide multiple secure data paths, each under the configuration control of a separate individual and/or organization. Thus, for example, router 202 can establish a first tunnel between router 202 and router 502 to route data securely from computer system 212 to computer system 512. While the first tunnel is operative, router 202 can establish a second, separate tunnel between router 202 and router 302 to route data from computer system 224 to computer system 312. Those of ordinary skill in the art will recognize that any number of such tunnels can be established by router 202.

The configuration allowing the first tunnel to be setup and used may be controlled by a first authorized user (e.g., a financial officer of a first bank) and used to route one type of data (e.g., confidential financial data), while the configuration allowing the second tunnel to be setup and used may be controlled by a second authorized user (e.g., a network engineer) and used to route the same or different type of data (e.g., network monitoring data). Each tunnel is allowed and setup based on configuration data provided by a corresponding configuration device, presented to the router alone or in conjunction with the maintenance device, and loaded into volatile storage within the router as part of the router's configuration. Thus, for example, configuration device C2-1 provides the configuration data and/or at least some of the authentication data related to routing data from computer system 212 to computer system 512 via one tunnel, while configuration devices C2-3 provides the configuration and/or authentication data related to routing data from computer system 224 to computer system 312 via another tunnel.

Although the above example divides the configuration stored in each configuration device based upon destination address of the computer systems and/or networks, other divisions are possible. Tunnels may be established based upon the type of data being transferred (e.g., financial data, network monitoring data, and camera and alarm data), and/or based upon who controls access to the data (e.g., a bank official, a security officer, or network maintenance personnel). For example, data provided by computer system 212 may include financial data from one bank that is being sent to computer system 414 at another bank. At the same time, the first bank may also provide video surveillance data from its security computer system to local police departments on an “as needed” basis if an alarm is detected.

Banking regulations generally do not allow any external, non-banking entities, such as a police department, to connect directly to a bank's network 210, due to the presence of confidential banking data on network 210. Router 202 provides a separate, secure tunnel through which only the video surveillance data is routed to such an external entity without giving the entity direct access to network 210, and without compromising confidential banking data. The tunnel is encrypted using different keys than the banking data, and is routed to a computer system operated by the police department (e.g., computer system 514) based upon rules that allow only this type of data to be routed to the police department's computer system. These rules may be stored on a separate configuration device, under the control of a person authorized to configure the routing of the video surveillance data, but not the financial data. As a result, the police department does not gain access to the banking data, the decryption keys used to decrypt the video surveillance data cannot be used to decrypt the banking data even if the police department did gain access to the financial data, and the person authorized to use the surveillance configuration device cannot alter the configuration of router 202 to gain access or decrypt banking data present on network 210.

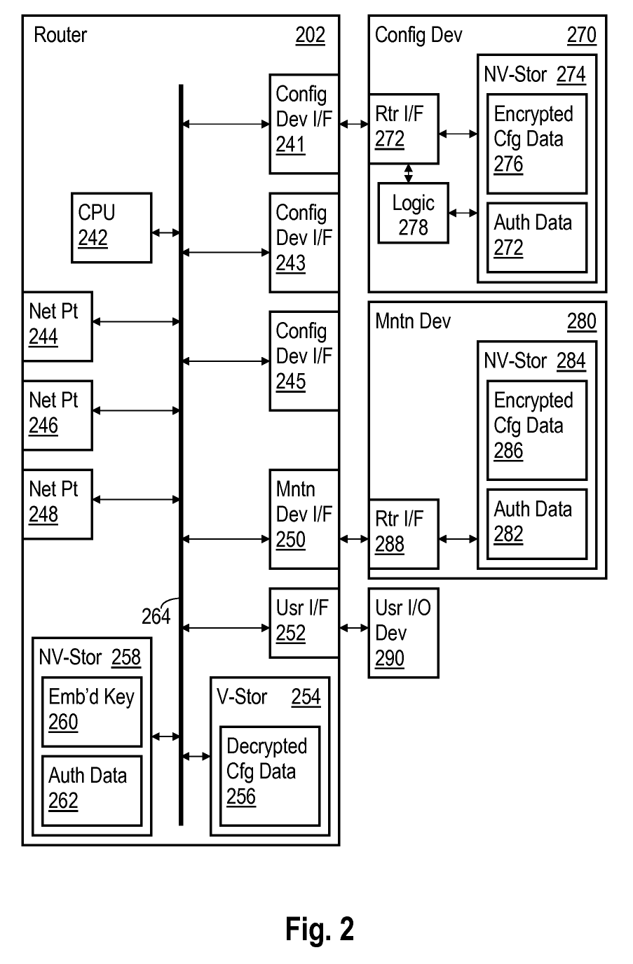

FIG. 2 shows a block diagram that details a router 202, constructed in accordance with at least some illustrative embodiments, and further details a configuration device 270 and a maintenance device 280, both coupled to router 202. Router 202 includes central processing unit (CPU) 242, network ports (Net Pts) 244, 246 and 248, configuration device interfaces (Config Dev I/Fs) 241, 243 and 245, maintenance device interface (Mntn I/F) 250, user interface (Usr I/F) 252, volatile storage (V-Stor) 254, and non-volatile storage (NV-Stor) 258, each of which couple to a common bus 264. CPU 242 controls the routing of data between network ports 244, 246 and 248, based on decrypted configuration data (Decrypted Cfg Data) 256 stored within volatile storage 254. The configuration data can be stored in encrypted form within configuration device (Config Dev) 270, which couples to router 202 via configuration device interface 241. Configuration device 270 includes router interface (Rtr I/F) 272 and non-volatile storage 274, each coupled to the other. Rtr I/F 272 may employ any of a variety of interface means to couple to Config Dev I/F 241 of the router 202. Such means include, for example, wired, optical, and/or wireless connections. Accordingly, Rtr I/F 272 comprises circuitry to implement the chosen interface, including, for example, a radio frequency transmitter and receiver. Non-volatile storage 274 stores encrypted configuration data (Encrypted Cfg Data) 276, which is provided to CPU 242 of router 202 while configuration device 270 is coupled to configuration device interface 241. CPU 242 uses embedded key (Emb'd Key) 260, stored within non-volatile storage 258, to decrypt the encrypted configuration data 276 to produce at least some of decrypted configuration data 256.

Maintenance device 280 includes router interface (Rtr I/F) 288 and non-volatile storage 284, each coupled to the other. Like Rtr I/F 272 described above, Rtr I/F 282 may employ any of a variety of interface means including, for example, wired, optical, and/or wireless connections to couple to Config Dev I/F 250 of the router 202. Non-volatile storage 284 stores additional encrypted configuration data (Encrypted Cfg Data) 286, which is provided to CPU 242 of router 202 while maintenance device 280 is coupled to maintenance device interface 250. CPU 242 uses embedded key (Emb'd Key) 260, stored within non-volatile storage 258, to decrypt the additional encrypted configuration data 286 to optionally produce at least some of decrypted configuration data 256. Maintenance device 280 is not required for normal operation of the router (“normal mode”), but is instead used to place the router into a “maintenance mode,” wherein authorized maintenance personnel can perform scheduled maintenance of the router, and/or troubleshoot problems with the router and network.

Access to the embedded key 260, and thus to the configuration data required to operate the router 202, via, for example, access to an embedded key (e.g., key 260), may be controlled using user-provided authentication data. In at least some illustrative embodiments, the authentication data is provided by a user operated user input/output device (Usr I/O Dev) 290, which is coupled to user interface 252. In some embodiments, the authentication data is provided by a user operated user input device coupled to the configuration device 270 and/or the maintenance device 280. The input provided by the user may be in the form of a password, or in the form of biometric data (e.g., scanned fingerprint or retinal data). The authentication data may then be compared to stored and/or encrypted reference copies of the authentication data, which may be stored locally within router 202 in non-volatile storage 258 (Auth Data 262), externally in non-volatile storage 274 within configuration device 270 (Auth Data 272), and/or externally in non-volatile storage 284 within maintenance device 280 (Auth Data 282).

It should be noted that although the illustrative embodiment of FIG. 2 does not show additional configuration devices coupled to configuration device interfaces 243 and 245, any number of configuration devices may be coupled to router 202. Decrypted configuration data 256, stored in volatile storage 254, results from decrypting and combining the encrypted configuration data stored in each configuration device (and optionally the maintenance device) coupled to router 202. Other illustrative embodiments may include any number of configuration device interfaces. Also, software executing on CPU 242 may allow multiple configuration devices to be sequentially coupled to, authenticated, and uncoupled from a single configuration device interface, extending the number of configuration devices that may be used to configure the router. Other techniques and configurations for increasing the number of configuration devices that may be used to configure router 202 will become apparent to those of ordinary skill in the art, and all such techniques and configurations are within the scope of the present disclosure.

As described above, some embodiments of a system 100 require that a router (e.g., router 202) be physically coupled to configuration device 270 and/or maintenance device 280 to configure the router. Consequently, if a first individual has physical control of the router and a second individual has physical control of the configuration device, the second individual requires physical access to the router for attachment of the configuration device. Such an access requirement effectively creates a single security zone. The term “security zone” as used herein refers to a spatial area controlled by a specific individual or group, which only that individual or group is permitted to access. At least some embodiments of the present disclosure provide enhanced system security by implementing a plurality of physically separate security zones wherein the router is present in a first security zone and a configuration device used to configure the router is present in a second security zone. The configuration device preferably never enters the router security zone. Such embodiments can provide enhanced security by requiring two distinct individuals located in two physically disparate security zones to enable router configuration.

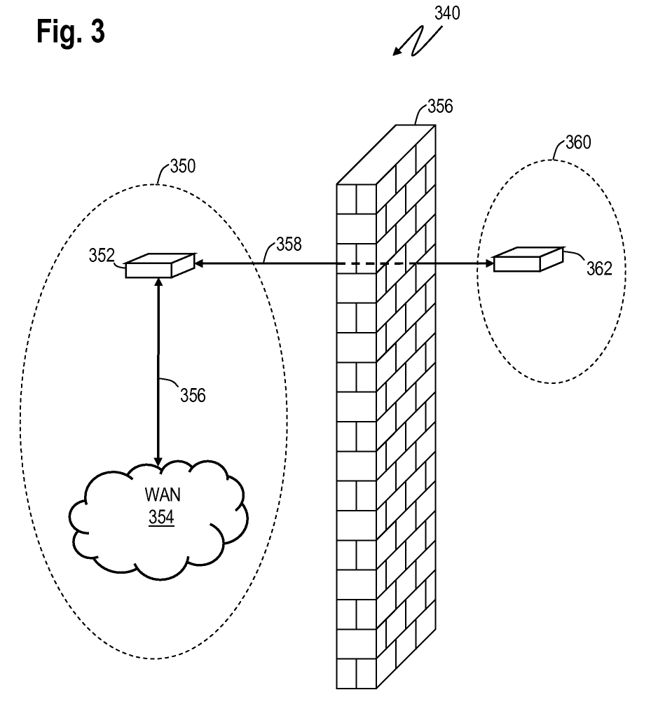

FIG. 3 shows a system 340 including a first security zone 350 and a second security zone 360. Security zone 350 is separated from security zone 360 by physical access barrier 356. Physical access barrier 356 prevents individuals allowed physical access to one security zone 350, 360 from gaining physical access to the other security zone 350, 360. In some embodiments, the security zones 350, 360 may be, for example, separate adjacent rooms providing separate alarmed keypad, biometric, or other identification based entry access control.

The first security zone 350 includes a router 352 coupled to a network 354 (e.g., a WAN) via a network link 356. The network link 356 may comprise any data communication technology for connecting the router 352 to the network 354. For example, the link 356 may comprise a wired or optical communication link, or a wireless communication link. Security zone 350 may be controlled by a single individual or group, for example, a network administrator, having exclusive access the security zone 350.

The second security zone 360 includes a configuration device 362. Embodiments of the configuration device 362 can include the various features described above with regard to a configuration device (e.g., configuration device 270). Configuration device 362 remotely couples (i.e., couples without direct physical contact) to the router 352 to configure the router 352. The second security zone 360 may be controlled by a different individual or group than the individual or group controlling the first security zone 350. For example, the second security zone 360 may be controlled by a security officer responsible for maintaining network security having exclusive access to security zone 360.

Because router 352 and configuration device 362 are located in different security zones 350, 360, embodiments of the present disclosure provide for coupling of the configuration device 362 and the router 352 without physically attaching the configuration device 362 to the router 352. Instead, the configuration device 362 remotely couples to the router 352 via configuration link 358. The configuration link 358 may be implemented as any of a variety of communication means that allow for secure data exchange between the configuration device 362 and the router 352 without requiring a direct physical attachment of the configuration device 362 to the router 352. For example, link 356 may be a wireless link, for example RF (e.g., IEEE 802.11), infra-red, laser, etc., wherein the connection between the router 352 and the configuration device 362 is encrypted and authenticated. In some embodiments the link 356 may be a wired or optical link connecting the router 352 and the configuration device 362 directly (e.g., through a detachable wire or optical cable) or through a network, and wherein the connection is encrypted and authenticated.

Establishment of configuration link 358 between the router 352 and the configuration device 362 requires the presence of an authorized individual in each the two separate security zones 350, 360 in at least some embodiments. Each individual may be authenticated to certify his authority to configure the router 352. Thus, the individual with authority over the router 352 may be authenticated to configuration device 362, and the individual with authority over the configuration device 362 may authenticated to the router 352. Authentication may be by password, iris scan, retinal scan, etc. as described above. Referring to FIG. 2, Logic 278 is coupled to Rtr I/F 272 and NV-Stor 274. Logic 278 is configured to verify router authentication data received via Rtr I/F 272. Logic 278 can comprise a processor, memory, and software programming that provides the various authentication and communication functions required to communicate with and configure the router 352.

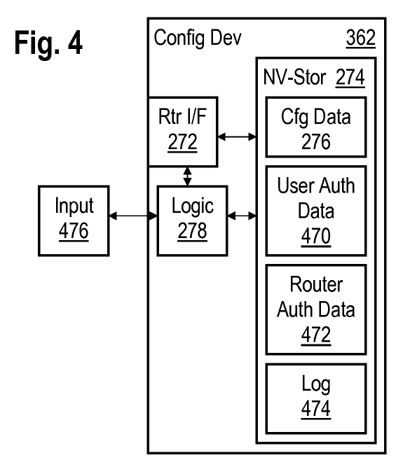

FIG. 4 shows a block diagram of a configuration device 362 adapted to remotely couple to a router 352 in accordance with various embodiments. The configuration device 362 is similar to configuration device 270 explained above. Router interface (Rtr I/F) 272 allows the configuration device 362 to remotely couple to the router 352. Rtr I/F 272 may employ any of a variety of interface means to provide remote coupling to router 352. Such means include, for example, infra-red and/or RF connections.

Embodiments of configuration device 362 include various types of data in NV-Stor 274. Embodiments include configuration data (Cfg Data) 276 that, as explained above, defines the secure data paths, or “tunnels” allowing transfer of data from one router to another. Cfg Data 276 is supplied by configuration device 362 to router 352 while configuration device 362 is remotely coupled to router 352. In some embodiments, Cfg Data 276 may be encrypted. In such embodiments, Cfg Data 276 may be transmitted in encrypted form to the router where CPU 242 uses embedded key (Emb'd Key) 260, stored within non-volatile storage 258, to decrypt the encrypted configuration data 276 to produce at least some of decrypted configuration data 256. In some embodiments, encrypted Cfg Data 276 may be decrypted, based on user authentication, prior to transmission to a router.

User authentication data (User Auth Data) 470 is included, in some embodiments, to allow for validation of authorized configuration device 362 users and/or authorized router 352 users. Authentication data may include user identification, user name, user biometric data, user access level and/or other data for verifying a user's identity or restricting user access. An input device 476 (e.g., a fingerprint scanner, keyboard, etc.) coupled to the configuration device 362 can provide configuration device user authentication input data. In some embodiments, the input device 476 is incorporated into the configuration device 362. Some embodiments decrypt Cfg Data 276 and/or provide Cfg Data 276 to a remotely coupled router only if the user authentication is successful.

Router authentication data (Router Auth Data) 472 is included, in some embodiments, to allow for validation of routers to which the configuration device 362 may provide Cfg Data 276 when remotely coupled. Authentication data may include, for example, router identification, router name, router wireless address, router IP address, router public encryption key, or router access level. Router authentication input is received via Rtr I/F 272. Embodiments provide Cfg Data 276 to a remotely coupled router only if the router authentication is successful.

Log 474 is included, in some embodiments, to provide a record of configuration device 362 interaction with users and/or routers. Information recorded in the log may include, for example, various information for tracking configuration device 362 activities, including user and/or router provided authentication data and identities of authenticated users and/or routers interacting with the device 362, interaction time-stamps, etc. Log data may be provided to a monitoring system to further enhance network security.

Thus, embodiments of the present disclosure allow for distinct router administration and configuration. Physical attachment of the configuration device to the router is not required to perform router configuration. Instead, the configuration device may be remotely connected to the router with mutual authentication and encryption via a configuration link. The router and the configuration device can reside in separate physical security zones, enhancing network security by ensuring that two individuals, one in each security zone, must act simultaneously to configure the router. Further, enabling remote router configuration eliminates the need for personnel not directly responsible for datacenter operations to access datacenter facilities. Because fewer personnel have access to the datacenter, network security is further enhanced.

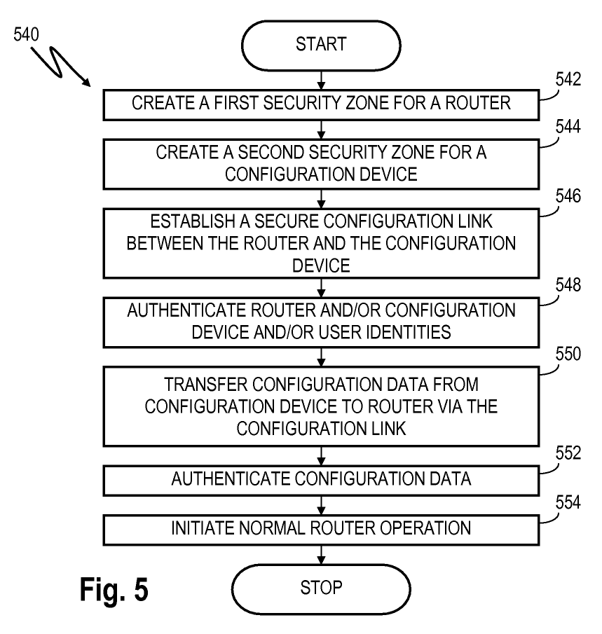

FIG. 5 shows a flow diagram 540 for a method for configuring a router 352 using a configuration device 362 in accordance with various embodiments. In some embodiments, the router 352 is in a first security zone 350 and the configuration device 362 is in a second security zone 360. Though depicted sequentially as a matter of convenience, at least some of the actions shown can be performed in a different order and/or performed in parallel. Moreover, some embodiments may perform only some of the illustrated actions. In block 542, a first security zone 350 is created. The first security zone 350 includes a router 352. The first security zone 350 generally comprises a physical area to which access is restricted to a specific individual or group. For example, access to the first security zone 350, may be restricted to a system administrator or an entity's information technology department personnel.

In block 544, a second security zone 360 is created. The second security zone 360 includes a configuration device 362. The configuration device 362 includes data unique to the configuration of the router 352, such as encryption keys for communicating with other routers and/or data defining a tunnel from the router 352 to another router. Like the first security zone 350, the second security zone 360 generally comprises a physical area to which access is restricted to a specific individual or group. Access to the second security zone 360 may be restricted to, for example, an entity's security officer or other personnel responsible for maintaining the security of network data transfers. In one embodiment of security zones 350, 360, each security zone 350, 360 comprises a room adjacent to the other security zone 350, 360, with each security zone 350, 360 including separate alarmed keypad entry controlled access. Groups with access to one security zone are preferably unable to access the other security zone.

In block 546, a secure configuration link 358 between the router 352 and the configuration device 362 is established. Embodiments of the router 352 and the configuration device 362 encrypt data transferred across the link 358. The means of data transfer on the secure configuration link 358 may be, for example, wireless, wired, optical, direct, or networked. In some embodiments, the router 352 and/or the configuration device 362 may authenticate a user of one or both units. The router 352 may authenticate its user and/or the user of the configuration device 362. Similarly, the configuration device 362 may authenticate its user and/or the user of the router 352. User authentication may require, for example, entry of a secret password or validation of user entered biometric data, such as fingerprints, retinal patterns, and/or iris patterns. Moreover, embodiments may authenticate the identity of the other unit 352, 362 against, for example, a stored list of particular units that may provide/receive configuration information to/from the authenticating unit. If unit or user authentication fails, the configuration session terminates.

In block 550, after the secure communication link 358 is established and user and/or device authentication is successful, configuration data is transferred from the configuration device 362 to the router 352 via the configuration link 358. The configuration data may be stored in the configuration device 362 in encrypted form and decrypted only upon successful user authentication. The configuration data may be encrypted for transmission in accordance with an encryption key unique to the router 352.

The configuration data transferred to the router 352 from the configuration device 362 is authenticated by the router 352 in block 552 (e.g., the configuration data includes a digital signature). If configuration data verification fails, the configuration data is discarded and the configuration process terminates. If the configuration data is authenticated, the router applies the configuration data and, in block 554, initiates normal router 352 operation.

Thus, embodiments of the present disclosure allow for implementation of separate physical security zones for a router and a configuration device, wherein the configuration device provides information for configuring the router. Consequently, direct physical attachment of the configuration device to the router is not required to accomplish router configuration. Rather, a secure configuration link, comprising encryption and mutual authentication is established between the router and the configuration device. Configuration data is transferred from the configuration device to the router via the secure configuration link. The secure configuration link may transfer data using any appropriate data transfer technology, including wireless, wired, optical, point-to-point connections, networking, etc.

Moreover, because at least some embodiments of the invention neither require nor permit physical connection of a configuration device to a router, but rather provide for connection of router and configuration device with mutual authentication and encryption, embodiments avoid the potential security issues associated with allowing direct physical connection of a removable data device to an encryption device, and thus provide compliance with Federal Information Processing Standard 140, Level 2.

The above disclosure is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a first router; and
an external storage device that contains data that configures the first router;
wherein the external storage device is remotely coupled to the first router to configure the first router, and the data that configures the first router comprises the definition of a secure data path between the first router and a second router.

2. The system of claim 1, wherein the first router is located in a first security zone, and the external storage device is located in a second security zone isolated from the first security zone.

3. The system of claim 2, wherein a first entity controls the first router and a second entity controls the external storage device and the presence of both the first and second entities are required to enable router configuration.

4. The system of claim 3, wherein access to the first security zone is restricted to the first entity and access to the second security zone is restricted to the second entity.

5. The system of claim 1, wherein the first router further comprises an interface for entry of router user authentication data.

6. The system of claim 1, wherein the external storage device further comprises an interface for entry of external storage device user authentication data.

7. The system of claim 1, wherein an identity of a first router user is authenticated to the external storage device, and an identity of an external storage device user is authenticated to the router to enable configuration of the router by data from the external storage device.

8. The system of claim 1, wherein the router and the external storage device cannot be physically connected to one another.

9. The system of claim 1, wherein the first router and the external storage device are remotely coupled via an encrypted and authenticated communication link.

10. The system of claim 9, wherein the communication link is wireless.

11. The system of claim 1, wherein the external storage device authenticates at least one of the user of the external storage device and the identity of the first router, and the first router authenticates the identity of the user of the first router.

12. The system of claim 1, wherein the first router and external storage device maintain a communication link for no more than a time period allowing transfer of configuration data from the external configuration device to the first router.

13. A method, comprising:
establishing a secure communication link between a first router and an external storage device, the secure communication link remotely coupling the external storage device to the first router; and
transferring configuration data from the external storage device to the first router to configure a secure data path between the first router and a second router.

14. The method of claim 13, further comprising locating the first router in a first security zone, and locating the external storage device in a second security zone isolated from the first security zone.

15. The method of claim 14, further comprising restricting access to the first security zone to a set of individuals that excludes individuals authorized to control the external storage device.

16. The method of claim 14, further comprising restricting access to the second security zone to a set of individuals that excludes individuals authorized to control the first router.

17. The method of claim 13, further comprising authenticating to the first router at least one of an identity of an individual controlling the external storage device and an identity of an individual controlling the first router.

18. The method of claim 13, further comprising authenticating to the external storage device at least one of an identity of an individual controlling the router, an identity of an individual controlling the external storage device, and an identity of the first router.

19. The method of claim 13, further comprising authenticating configuration data transferred from the external storage device in the first router.

20. A storage device, comprising:
a router interface that remotely couples the storage device to a first router; and
router configuration data comprising information defining a secure data path between the first router and a second router.

21. The storage device of claim 20, wherein the storage device remotely couples to the first router via a secure configuration link.

22. The storage device of claim 20, wherein the router interface comprises a wireless transmitter and a wireless receiver.

23. The storage device of claim 20, further comprising identification data for each authorized user of the storage device.

24. The storage device of claim 20, further comprising data identifying routers to which the storage device can provide configuration data.

25. The storage device of claim 20, further comprising an interface for entry of user authentication data.

26. The storage device of claim 25, wherein the interface comprises a biometric sensor.

27. The storage device of claim 20, further comprising a log that records user authentication data entered on each attempt to access the device.

28. The storage device of claim 20, wherein at least one of the router configuration data, authorized user identification data, first router identification data, and log data stored in the device is encrypted.

29. The storage device of claim 20, wherein the router configuration data is cryptographically signed so the first router can verify the integrity of the configuration data provided by the storage device.

30. The storage device of claim 20, wherein the storage device transfers router configuration data stored in the device to the first router only if the first router and the storage device user are authenticated.

31. The storage device of claim 20, wherein the storage device authenticates the identity of a first router user.
